(19) United States
(12) Patent Application Publication
(10) Pub. No.: US 2008/0257643 A1
(43) Pub. Date: Oct. 23, 2008

(54) RESCUE DEVICE AND METHOD THEREFOR

(76) Inventors: John T. Weinel, Lakeville, MN (US); Thomas Waclo, Olympic Valley, CA (US); Will Paden, Olympic Valley, CA (US)

Correspondence Address: SCHWEGMAN, LUNDBERG & WOESSNER, P.A., P.O. BOX 2938, MINNEAPOLIS, MN, 55402, US

(21) Appl. No.: 11/738,765

(22) Filed: Apr. 23, 2007

(51) Int. Cl. E06C 5/44

(52) U.S. Cl. 182/18

(57) ABSTRACT

A rescue device for use by a user in a material slide includes a bundle having an inflatable bladder in a storage position. Optionally, a harness is coupled to the bundle. In one example, the bundle is adapted to be selectively secured to a backpack. A tether constrains the inflatable bladder. In another example, the tether constrains the bladder to remain within a predetermined distance from a connection device. In another example, the tether constrains the inflatable bladder in a deployed position to around a head of the user. The inflatable bladder, when deployed, is generally buoyant in the material slide and pulls the user proximate to a top surface of the material slide. Optionally, the inflatable bladder, when in a deployed position, is immediately adjacent the user to aid in protecting the user against blunt force trauma from the material slide.

### TECHNICAL FIELD

This patent document pertains generally to rescue devices and, more particularly, to emergency flotation rescue devices usable in materials slides such as avalanches and landslides.

### BACKGROUND

Many of the current personal recovery and rescue devices are not compact and portable. For instance, the devices are often cumbersome assemblies carried on the back. The back mounted recovery device includes a large inflatable bladder and a gas canister coupled to the bladder. The size of these back mounted devices precludes using a backpack to store equipment including camping gear, survival gear, food, water and the like. In some examples, skiers, hikers, snowmobilers, rescue personnel and the like use a backpack (e.g., for storage and the like) instead of using a back mounted recovery device. Further, in some examples, the back mounted devices are heavy and limit the amount of equipment the user may comfortably carry in pockets and coats. In still other examples, it is the policy of ferrying services (e.g., helicopter ferries) that transport back country skiers and hikers to remote locations to not allow the use of a cumbersome backpack or back mounted recovery device that can decrease the mobility of the user in an avalanche situation. In yet other examples, ski patrol officers are precluded from wearing back mounted recovery devices because they carry avalanche triggering explosives on their backs.

What is needed is rescue harness that overcomes the shortcomings of previous devices. What is further needed is a rescue device that is compact and portable, and provides an increased chance of survival and decreases the severity of injuries in a material slide such as an avalanche or landslide.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a front view of one example of a rescue device;

FIG. 2 is a rear view of the rescue device of FIG. 1;

FIG. 3 is a front view of the rescue device of FIG. 1 with an inflatable bladder removed from a pouch;

FIG. 4 is a front view of the rescue device of FIG. 3, the inflatable bladder in a deployed position;

FIG. 5 is a front view of another example of a rescue device with an inflatable bladder in a deployed position;

FIG. 6 is a rear view of the rescue device of FIG. 4;

FIG. 7 is a front view of one example of a rescue device positioned around a chest of a user;

FIG. 8 is a front view of one example of a rescue device positioned around a waist of a user;

FIG. 9 is a side view of one example of a rescue device positioned around a waist of a user;

FIG. 10A is a rear view of one example of a rescue device positioned around a waist of a user;

FIG. 10B is a front view of one example of a rescue device positioned around a waist of a user;

FIG. 11 is a front view of one example of a rescue device positioned around a waist of a user, the rescue device having an inflatable bladder in a deployed position;

FIG. 12 is a rear view of one example of a rescue device positioned around a waist of a user, the rescue device having an inflatable bladder in a deployed position;

FIG. 13 is a front view of another example of a rescue device;

FIG. 14 is a rear view of the rescue device of FIG. 13;

FIG. 15 is a front view of the rescue device of FIG. 13, the rescue device having an inflatable bladder in a deployed position;

FIG. 16 is a rear view of the rescue device of FIG. 14; and

FIG. 17 is a block diagram showing one example of a method of making a rescue device.

### DESCRIPTION OF THE EMBODIMENTS

The following detailed description includes references to the accompanying drawings, which form a part of the detailed description. The drawings show, by way of illustration, specific embodiments in which the present subject matter may be practiced. These embodiments, which are also referred to herein as “examples,” are described in enough detail to enable those skilled in the art to practice the present subject matter. The embodiments may be combined, other embodiments may be utilized, or structural changes may be made without departing from the scope of the present subject matter. The following detailed description is, therefore, not to be taken in a limiting sense, and the scope of the present subject matter is defined by the appended claims and their equivalents.

In this document, the terms “a” or “an” are used, as is common in patent documents, to include one or more than one. In this document, the term “or” is used to refer to a nonexclusive “or”, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

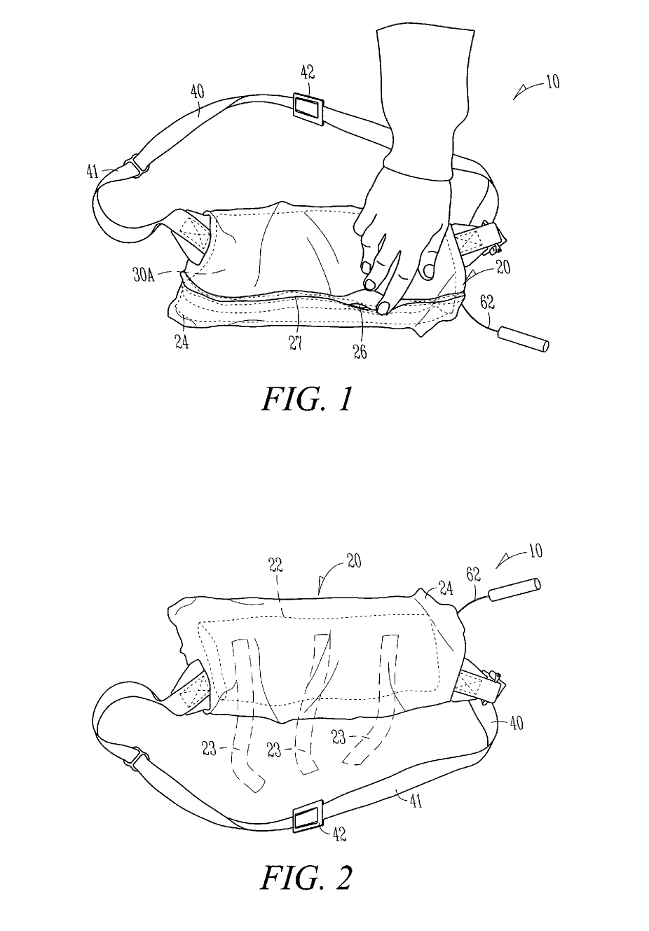

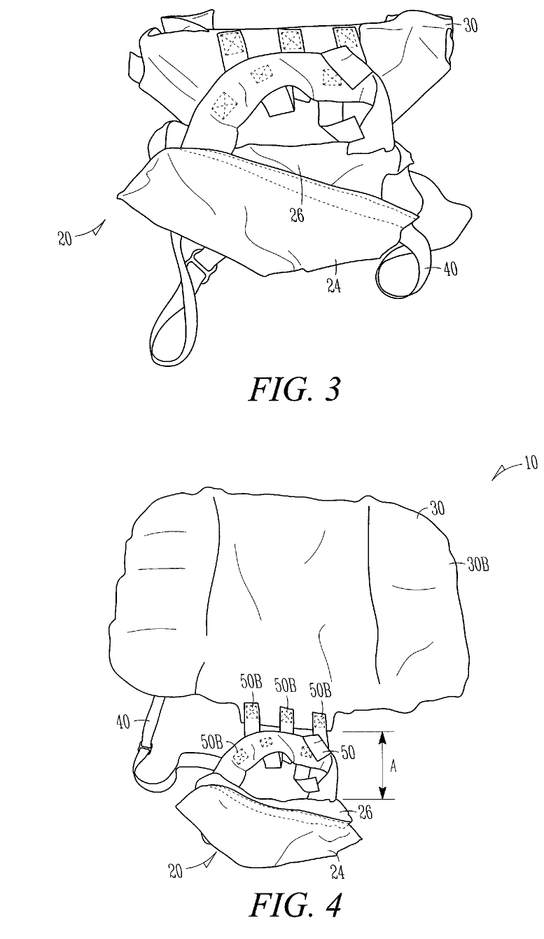

Referring to FIGS. 1-17, there are shown examples of rescue devices and a method of making a material slide rescue device in accordance with the present invention. Such a rescue device can be used, for instance, to provide a device that is compact and portable, provides an increased chance of survival, and decreases the severity of injuries in a material slide, such as, for instance, an avalanche or landslide. Such a rescue device 10 can be used, for instance, during skiing, hiking, snowmobiling, climbing, rescue operations, and other such activities in which there is a possibility that a material slide or the like will occur.

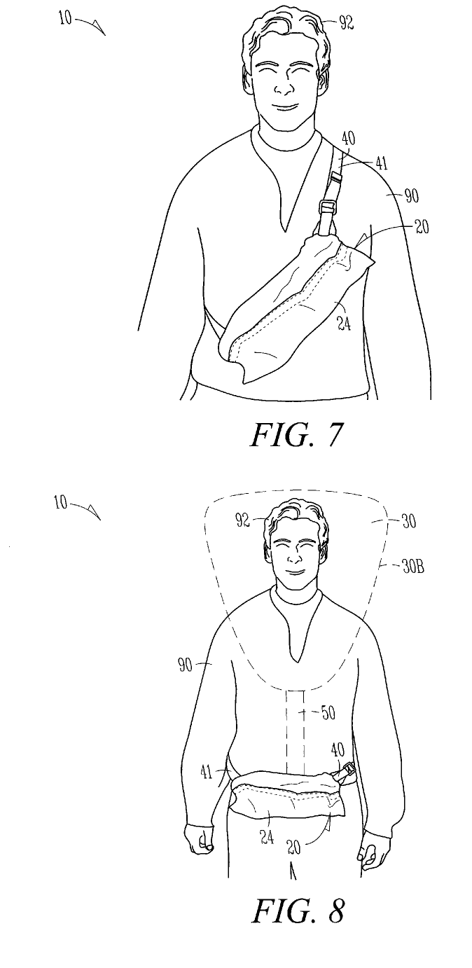

Referring first to FIGS. 1-4, 7, 8, and 10A, one example of a rescue device 10 includes a bundle 20 having an inflatable bladder 30 therein when in a storage position 30a. In one example, the bundle 20 houses the inflatable bladder 30, at least one gas canister (discussed in more detail below), and an opening mechanism (discussed in more detail below) coupled thereto. As shown in FIG. 1, a portion of the opening mechanism including a manual trigger, such as a rip cord 62, extends outside of the bundle 24. In one example, the bundle 24 is coupled to a harness 40, which is configured to secure the bundle 24 to a user 90 (see, for instance, FIG. 8). Optionally, the bundle 24 is coupled with the harness 40 using, for instance with adhesives, welds, fasteners, stitching and the like. Optionally, the harness 40 includes a vest, webbing, and the like sized and shaped to position the rescue device 10 on the user 90. As shown in FIGS. 1 and 2, in one example, the harness 40 includes a strap 41 that can be used to position the rescue device 10 in various configurations on the user 90, for instance, around the waist of the user 90 in a waist belt or fanny pack configuration (see FIGS. 8 and 10A), around the chest of the user 90 in a shoulder belt configuration (see FIG. 7), and the like. The strap 41 is adjustable, in yet another example, to facilitate fitting the rescue device 10 around a variety of users having different body types, weights, sizes, and the like. Other examples of the harness 40 are sized and shaped to fit around the user 90, other users, objects, and the like in different configurations.

The inflatable bladder 30, is constructed with or includes, for example, a polymer suitable for use in water or snow and is substantially gas impermeable. In another example, the inflatable bladder 30 includes polyethylene, polypropylene, polyester, polyurethane, polyvinyl chloride, or the like. In yet another example, a suitable polymer is combined with fibrous polymers such as nylon or aramid fiber. In yet another example, the inflatable bladder 30 is gas permeable in that it allows gas to relatively slowly bleed out of the inflatable bladder 30. In this example, the inflatable bladder 30 remains sufficiently inflated during the avalanche or other material slide event, but allows the air to bleed out to enable the air from the inflatable bladder 30 to be breathed by the user if buried. In this way, the chance of survival of the user can be enhanced if buried within the material slide by prolonging the air supply of the user to allow the user more time to dig out of the material slide or allow rescuers more time to find and uncover the user.

As described above, the inflatable bladder 30, in one example, is stored in the pouch 24 and is inflated by pulling on a trigger, such as the rip cord 62. The rip cord 62 is coupled with at least one gas canister 64 that contains a compressed gas (e.g., carbon dioxide, air, and the like). As shown in FIG. 6, the rip cord 62 is coupled with one gas canister 64. The gas canister 64 is coupled to a venturi 66, which acts to draw into the inflatable bladder 30 ambient air along with the compressed gas within the gas canister 64, thereby decreasing the amount of compressed gas required to be equipped with the rescue device 10. For instance, an inflatable bladder 30 that would require two gas canisters of compressed gas to fill could be filled with only one gas canister fitted with an appropriate venturi. Additionally, by using a venturi, a smaller gas canister could be used in place of a relatively larger gas canister.

Pulling the rip cord 62 pulls an opening mechanism 60 coupled with the gas canister 64. The opening mechanism 60 includes features such as needles, valves, and the like adapted to open the gas canister 64 when the rip cord 62 is pulled. The gas canister 64 is coupled to the opening mechanism 60, for example, by screwing the gas canister 64 into a threaded receptacle of the opening mechanism 60. In another example, the gas canister 64 is coupled to the opening mechanism 60 by welds, interference fits, quick connects, snap fits, and the like. The opening mechanism 60 is coupled to the inflatable bladder 30 through the venturi 66 to facilitate the flow of gas from the gas canister 64 and air from the surroundings to the inflatable bladder 30.

In another example, the harness 40 including the strap 41 includes a connection device 42 to couple the harness 40 to the user 90. The connection device 42 of this example facilitates securing and removal of the rescue device 10. In a further example, the connection device 42 includes quick connect features to facilitate rapid positioning and removal of the rescue device 10. For instance, the quick connect features include, but are not limited to, buckles, snap-fitting buckles, hook and loop fasteners, laces (e.g., for knotting and/or tying), and the like.

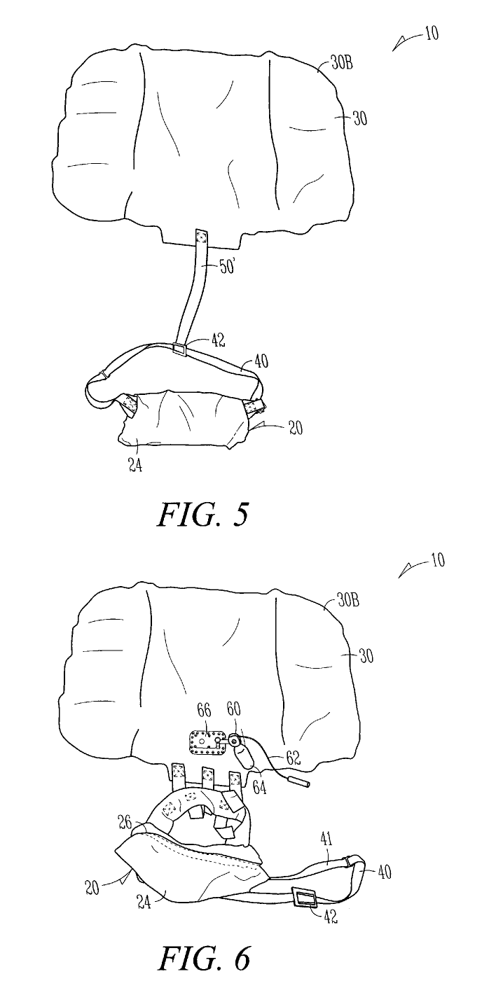

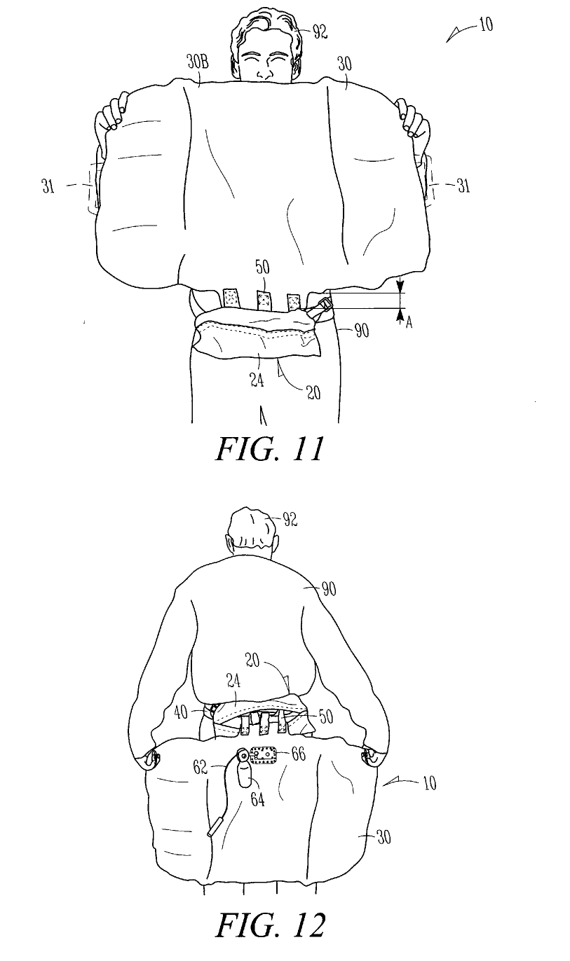

Referring to FIGS. 4 and 11, in one example, a tether 50 operatively couples the inflatable bladder 30 to the harness 40. The tether 50 acts to constrain, at least in part, the inflatable bladder 30 to remain within a predetermined distance A from the harness 40. In this way, the tether 50 retains the inflatable bladder 30 within the predetermined distance A to place the inflatable bladder 30, when in a deployed position 30b, immediately adjacent the user 90 to aid in protecting the user 90 against blunt force trauma from the material slide. In this example, the immediately adjacent inflatable bladder 30 is maintained directly next to, and in some instances abutting, the user 90 so that the inflatable bladder 30 is able to shield the user 90 from the material slide or debris, trees, rocks, and the like encountered in the material slide. Optionally, the tether 50 constrains the inflatable bladder 30 within the predetermined distance A to maintain the inflatable bladder 30, when deployed, immediately adjacent the user 90 to allow the user 90 to continue skiing after deploying the inflatable bladder 30. In one example, the inflatable bladder 30, when inflated in the deployed position 30b, is generally buoyant in the material slide to pull the user 90 proximate to a top surface of the material slide. The tether 50 in one example includes a loop 50a attached to at least one of the harness 40 and the pouch 24. Three attachment straps 50b are coupled between the loop 50a and the inflatable bladder 30, the attachment straps 50b acting to spread out a load during use of the rescue device 10 to lessen the likelihood of tearing of the attachment straps 50b and/or the inflatable bladder 40. Moreover, while a particular configuration of inflatable bladder 30 and tether 50 is shown in FIGS. 4 and 11, it is not intended to be limiting. For instance, while three attachment straps 50b are shown, it is contemplated that there be more or less than three attachment straps 50b, provided the attachment straps are capable of withstanding the forces experienced during use of the rescue device 10. It is further contemplated that at least one of the inflatable bladder and tether have different configurations, some of which are portrayed in FIGS. 5, 8, 10A, and 10B.

For instance, an example of a tether 50′ that is coupled to the connection device 42 is shown in FIGS. 5 and 10B. The tether 50′ is portrayed as a single strap coupled between the connection device 42 and the inflatable bladder 30. Such a configuration enables the user 90 to wear the rescue device 10 with the bundle 20 positioned generally at the small of the back so as to be generally less intrusive to the user 90 than if it were positioned at the front of the user 90, but brings the inflatable bladder 30 around to the front of the user 90 when deployed so as to provide at least some protection of the front of the user 90. For instance, the tether 50′ can be configured so as to allow the inflatable bladder 30 to be positioned around the head 92 of the user 90 when in the deployed position 30b. In this way, the inflatable bladder 30 can provide at least some protection against blunt force trauma as a result of a material slide or other such event. In one example of such a configuration, the harness 40 is positioned so the connection device 42 is disposed substantially proximate a frontal vertical midline X (see FIG. 10B) of the user 90 in order to facilitate positioning of the inflatable bladder 30 proximate the head 92 of the user 90 when the inflatable bladder 30 is deployed during a material slide or other such event. The tether 50′ of this example retains the inflatable bladder 30 within a predetermined distance A′ from the connection device 42 to place the inflatable bladder 30, when in a deployed position 30b, proximate the head 92 of the user 90. In this example, when the inflatable bladder 30 is in the storage position 30a, the tether 50′ is placed along one side of the harness 40 from the connection device 42 to the inflatable bladder 30 within the pouch 24. It is contemplated that the tether 50′ be removably or non-permanently coupled to (or at least partially along) the harness 40 by rip-stiching, Velcro®, or the like to enable the tether 50′ to be ordinarily retained on the harness 40 when the inflatable bladder 30 is in the storage position 30a, but to allow the tether 50′ to separate from the harness 40 when the inflatable bladder 30 is deployed to allow the inflatable bladder 30 to achieve positioning proximate the head 92 of the user 90. For example, the tether 50′ separates from the harness 40 due to pulling forces experienced by the inflatable bladder 30 in a material slide.

Optionally, the tether 50, 50′ is adjustable (e.g., with adjustable buckles, interchangeable tethers, and the like) to ensure that, upon inflation, the inflatable bladder 30 is positioned near the desired location, such as the head 92 of the user 90.

Referring now to FIG. 10A, in another example, the inflatable bladder 30, when deployed, is sized and shaped to be substantially within a silhouette of the user 90. In this way, the inflatable bladder 30 can remain relatively out of the way in the deployed position 30b so as to allow the user 90 less impedance in out running or otherwise evading the material slide or other such occurrence, for instance by skiing, snowboarding, snowmobiling, or the like. In this example, by placing the bundle 20 at the small of the back of the user 90, and by having a shorter tether than, for instance, the tether 50′ shown in FIG. 10B, the inflatable bladder 30 remains at the back of the user 90 relatively close to the user 90 so as to inhibit the deployed inflatable bladder 30 from obscuring the vision of the user 90 and also to minimize movement of the deployed inflatable bladder 30, which could throw off the balance of the user 90 while evading the material slide.

Referring again to FIG. 8, the inflatable bladder 30 in one example has a substantially ring-shaped geometry sized and shaped to form a pocket for placement and protection of the head 92 of the user 90. In one example, the pocket is positioned generally proximate the mouth and/or nose of the user 90 to inhibit snow, ice, debris, and the like from the material slide from collecting around the mouth and/or nose of the user 90, thereby increasing the likelihood that the user 90 will be able to breathe if the user 90 should be overtaken by the material slide.

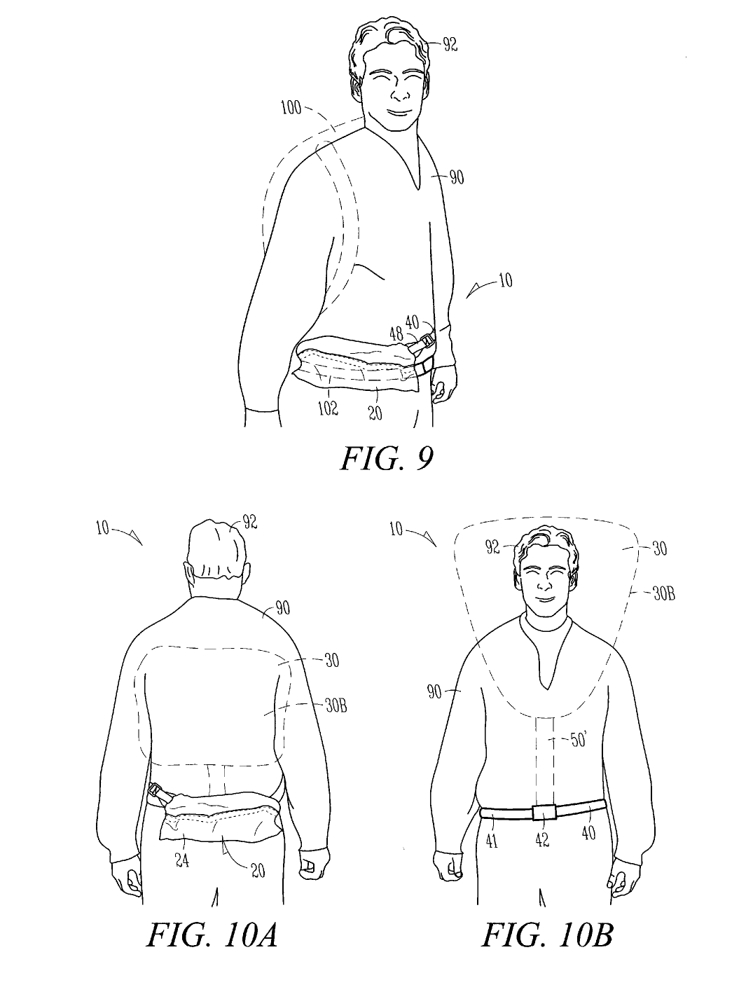

Referring now to FIGS. 2 and 9, in another example, the bundle 20 includes a sleeve 22 through which a waist belt 102 of a backpack 100 slides. In this way, the rescue device 10 can be coupled to the backpack 100 in order to secure the rescue device 10 to the user 90. In one example, the harness 40 can be eliminated, provided the waist belt 102 of the backpack 100 is sufficiently robust to withstand at least a certain amount of forces imparted thereto when the inflatable bladder 30 is deployed during a material slide or other such event. Optionally, the harness 40 is not eliminated and is used as a failsafe strap 48, which acts to redundantly secure the rescue device 10 to the user 90. In this way, should the waist belt 102 of the backpack 100 fail, the failsafe strap 48 acts to redundantly secure the rescue device 10 to the user 90. In the example shown in FIG. 9, the bundle 20 is positioned on a hip of the user 90; however, this is not intended to be limiting. As such, it is contemplated that the bundle 20 be positioned at any point along the waist belt 102 of the backpack 100. It is further contemplated in another example that the rescue device 10 be secured to the backpack 100 using at least one securing strap 23 that attaches to the backpack 100, for instance, the bottom of the backpack 100 so as to be positioned at the back of the user 90. In one example, the at least one securing strap 23 ties into at least one feature of the backpack 100. In another example, the at least one securing strap 23 has a buckle, clip, or connection device which attaches to a mating buckle, clip, or connection device on the backpack 100. In still another example, the snaps, Velcro®, quick-connect features, or the like are used to connect to mating features on the backpack 100, provided such attachment devices are capable of withstanding at least a certain amount of the forces imparted during a material slide or other such event in which the inflatable bladder 30 would be deployed.

Referring to FIG. 11, in one example, the inflatable bladder 30 includes handles 31 to enable the user 90 to better grip the inflatable bladder 30, when in the deployed position 30b. By gripping the handles 31, the user 90 has at least some ability to attempt to “steer” the inflatable bladder 30 within the material slide to avoid obstructions such as trees, rocks, crevasses, drop-offs, and the like. Moreover, by gripping the handles 31, the user 90 can keep the inflatable bladder 30 in a desired position, such as proximate the user 90 and/or in front of the head 92 of the user 90 to provide some protection from blunt force trauma, away from the head 92 of the user 90 so as to not obstruct the vision of the user 90 while trying to evade the material slide, and the like.

Referring again to FIGS. 1-4, in one example, the bundle 20 includes the pouch 24, which is adapted to split to create an opening 26. The opening 26 in one example is created by splitting a seam 27 adapted to split during inflation of the inflatable bladder 30 to allow the inflatable bladder 30 to be released from within the pouch 24. While called a pouch, it is contemplated that the pouch 24 be any type of container, provided the container is capable of performing as described herein. For instance, the container can be a casing or the like. In another example, the container is a binding (e.g., strap, tie, clamp, cords and the like) extending around at least a portion of the inflatable bladder 30. In yet another example, the inflatable bladder 30 is sized and shaped to have a shape substantially corresponding to the dimensions of the container or pouch 24 when the inflatable bladder 30 is in the storage position 30a. In yet another example, the inflatable bladder 30 extends around at least a portion of the gas canister 64 and the opening mechanism 40 when the inflatable bladder 30 is folded into the storage position 30a in the bundle 20. At least the gas canister 64 and the opening mechanism 60 are enveloped within the pliable inflatable bladder 30. Enveloping the gas canister 64 and the opening mechanism 60 helps to protect the gas canister 64 and the opening mechanism 60 from damage caused by, for instance, dropping of the bundle 20, other impacts, and the like. The inflatable bladder 30 serves to protect the gas canister 64 and the opening mechanism 60 during transport of the rescue device 10 (e.g., while hiking, skiing, snowmobiling, climbing, performing rescue operations, and the like). Additionally, folding the inflatable bladder 30 over the gas canister 64 and the opening mechanism 60 substantially protects the bundle 20 from damage when stored, for example, within a vehicle trunk or bed of a truck.

FIGS. 1-4 show one example of the pouch 24 of the bundle 20 in an open configuration. The pouch 24 in this example is pliable. Optionally, the pouch 24 is constructed with, but not limited to, pliable materials, such as nylon, polyester and the like. The pouch 24 is sized and shaped to split, for instance along the seam 27, to create the opening 26 as the inflatable bladder 30 inflates within the pouch 24. As the inflatable bladder 30 expands, it splits the pouch 24 and continues to inflate to its full volume. In another example, fasteners, such as hook and loop material, ties, rivets or the like are coupled along the seam 27 between sides of the pouch 24. The fasteners couple the sides of the pouch 24. The fasteners are sized and shaped to open and allow the pouch 24 to split under the tension force applied across the pouch 24 by inflation of the inflatable bladder 30. Alternatively, in other examples, the seam 27 of the pouch 24 is retained in the closed position by other methods, such as rip stitching, Velcro®, or the like.

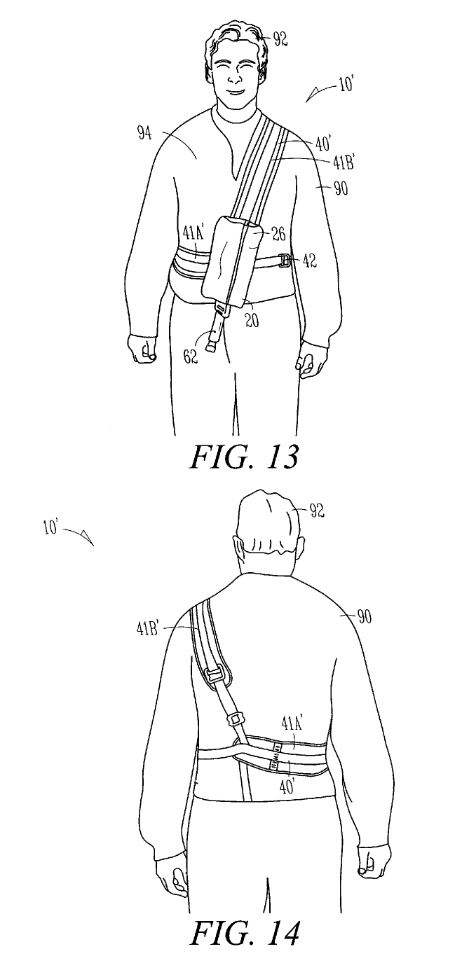

Referring now to FIGS. 13-16, another example of a rescue device 10′ is shown. While similar to the examples of the rescue device 10 shown in FIGS. 1-12, the rescue device 10′ of FIGS. 13-16 includes a harness 40′ in a bandolier configuration. That is, the harness 40′ includes a first strap 41a′, which, like the strap 41 of the harness 40, connects to the bundle 20 and extends around the waist of the user 90. The harness 40′ further includes a second strap 41b′, which extends around a shoulder of the user 90, with one end connecting to the bundle 20 and the other end connecting to the first strap 41a′. In this way, the first and second straps 41a′, 41b′ of the harness form a bandolier configuration. While this configuration is shown and described herein, it is within the spirit and scope of the present invention that other strap configurations are usable, provided such strap configurations are capable of securing the rescue device 10′ to the user 90. Moreover, while the bundle 20 is shown positioned on a chest 94 of the user 90, it is contemplated that the harness 40′ is configured to position the bundle 20 on the back of the user 90, if desired. In one example, at least one of the first and second straps 41a′, 41b′ includes a connection device 42 similar to that described above to facilitate positioning, securing, and/or removal of the rescue device 10′.

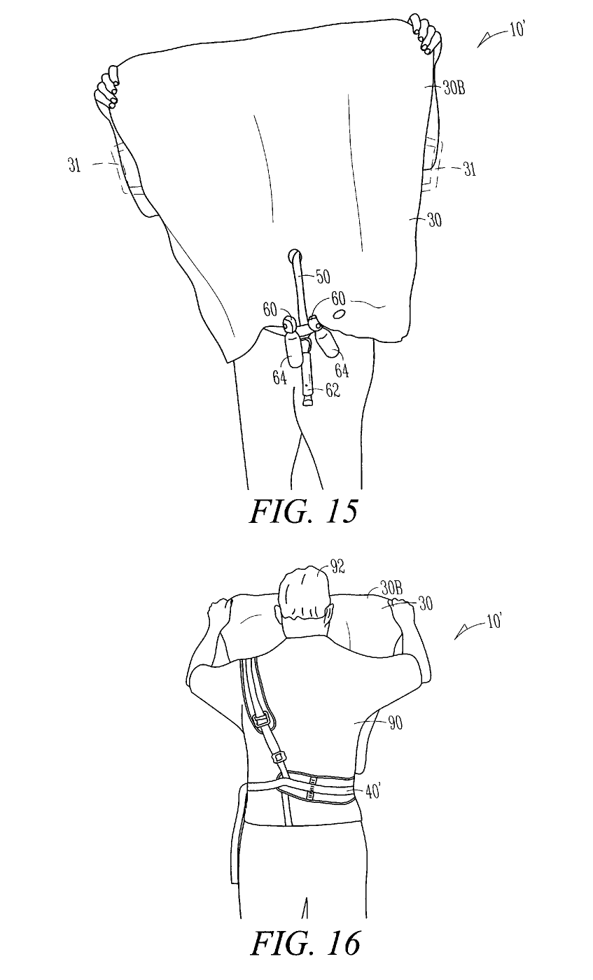

Referring specifically to FIGS. 15 and 16, one example of the inflatable bladder 30 is shown in the deployed position 30b. The inflatable bladder 30 is constructed with or includes, for example, a polymer suitable for use in water or snow and is substantially gas impermeable. In another example, the inflatable bladder includes polyethylene, polypropylene, polyester, polyurethane, polyvinyl chloride or the like. In yet another example, a suitable polymer is combined with fibrous polymers such as nylon or aramid fiber. In yet another example, the inflatable bladder 30 is gas permeable, as described above, to allow air to bleed out of the inflatable bladder 30 for the user to breathe if buried within the material slide. As described above with respect to the rescue device 10, the inflatable bladder 30, in one example, is stored in the bundle 20 (FIG. 13) and is inflated by pulling on a trigger, such as the rip cord 62. The rip cord 62 is coupled with at least one gas canister 64 that contains a compressed gas (e.g., carbon dioxide, air and the like). As shown in FIG. 15, the rip cord 62 is coupled with two gas canisters 64. Pulling the rip cord 62 triggers opening mechanisms 60, one opening mechanism 60 coupled with each of the gas canisters 64. The opening mechanisms 60 include features such as needles, valves, and the like adapted to open the gas canisters 64 when the rip cord 62 is pulled. The gas canisters 64 are coupled to respective opening mechanisms 60, for example, by screwing the gas canisters 64 into corresponding threaded receptacles of the opening mechanisms 60. In another example, the gas canisters 64 are coupled to the opening mechanisms 60 by welds, interference fits, quick-connects, snap fits, and the like. The opening mechanisms 60 are coupled to the inflatable bladder 30 to facilitate the flow of gas from the each of the gas canisters 64 to the inflatable bladder 30. It is noted that, in one example, the inflatable bladder 30 could be inflated using a venturi, as described above with respect to the rescue device 10.

In operation, the user 90 dons the rescue device 10, 10′, as shown in FIGS. 7-16. The bundle 20 including the inflatable bladder 30, the at least one gas canister 64, and the at least one opening mechanism 60 is positioned as desired on the user 90. In one example, the user 90 operates the rescue device 10, 10′ by actuating the trigger, for instance, the rip cord 62. In another example, the user 90 operates the rescue device 10, 10′ prior to a material slide, such as an avalanche, mudslide, rock slide and the like. In still another example, the user 90 operates the rescue device 10, 10′ after entering a material slide. Pulling the rip cord 62 actuates the at least one opening mechanism 60, thereby opening the at least one gas canister 64. As described above, the rescue device 10, 10′ optionally includes multiple opening mechanisms 60 and gas canisters 64. The gas canister 64 empties a gas into the inflatable bladder 30. The inflatable bladder 30 expands and, in yet another example, splits the container or pouch 24 as shown in FIGS. 11, 12, 15, and 16. Optionally, the inflatable bladder 30 splits apart the container or pouch 24 including cords, clamps, ties and the like extending around the inflatable bladder 30.

As the inflatable bladder 30 expands, its volume increases and it becomes buoyant within the material slide (e.g., the inflatable bladder 30 is less dense than snow, rock, mud, and the like found in material slides). In one example, the buoyancy of the inflatable bladder 30 pushes the inflatable bladder 30 toward the upper surfaces of the material slide and thereby pulls the user 90 toward the upper surface, as well. Because the inflatable bladder 30 moves the user 90 closer to the surface of the material slide, the user 90 has an increased chance of access to air and of extricating himself. Additionally, in another example, the inflatable bladder 30 has enhanced visibility, such as a bright color, to alert rescue personnel of the location of the user 90. The buoyant inflatable bladder 30 thereby provides at least visual notification of the approximate location of the user 90 in the material slide.

As the user 90 is pulled and pushed along by the material slide, the inertia of the inflatable bladder 30 moves the inflatable bladder 30, constrained by the tether 50, 50′, the predetermined distance A, A′ from the bundle 20 or connection device 42. In another example, the inflatable bladder 30 is retained near the head 92 of the user 90. In still another example, the tether 50, 50′ retains the pocket in the inflatable bladder 500 near the mouth of the user 90 to facilitate the passage of air to the user 90 through the material slide. As shown in FIGS. 11 and 15, optionally, the inflatable bladder 30 includes handles 31. In one option, the user 90 grabs the handles 31 to hold the inflatable bladder 30 close to the head 92 to provide some protection from injury during the material slide. Additionally, the user 90 holds the inflatable bladder 30 close to the mouth to assist in providing a passage for air between the upper surface of the material slide and the user 90. Further, in at least one example, because the tether 50, 50′ is sized to position the inflatable bladder 30 near the head 92 of the user 90, the visible inflatable bladder 30 (e.g., the brightly colored inflatable bladder 30) establishes the location of the head 92 of the user 90 in the material slide.

In another example, as the material slide moves the user 90, the buoyant inflatable bladder 30 provides at least some drag to the user 90 through the tether 50, 50′. In one example, the inflatable bladder 30 is coupled to the harness 40, 40′ near the chest 94 of the user 90 by the tether 50, 50′. Optionally, the inflatable bladder 30 is coupled to the bundle 20 or connection device 42, and the tether 50, 50′ acts to ensure the inflatable bladder 30 is retained at the predetermined distance A, A′ (e.g., a distance away from the center of gravity of the user 90 adjacent to the waist). The relatively short length of the tether 50, 50′ extending between inflatable bladder 30 and the bundle 20 or connection device 42 allows the drag from the inflatable bladder 30 to rotate the user 90 within the material slide so the head 92 is pointing in the upstream direction of the material slide (e.g., uphill). In another example, the drag from the inflatable bladder 30 is transmitted along the tether 50, 50′, thereby turning the head 92 of the user 90 around the center of gravity near the waist of the user 90. The head 92 thereby points upstream and is turned away from downstream obstacles such as trees, rocks, ravines, cliffs and the like. Additionally, because the inflatable bladder 30 is coupled with the harness 40, 40′ on the front of the user 90, for instance by the tether 50, 50′, the body of the user 90 is turned to face upward by the buoyancy of the inflatable bladder 30 in the material slide. The user 90 is thereby positioned near the surface of the material slide and facing upward to assist in both extraction from the slide (by the user or others) and breathing within or through the pocket of the inflatable bladder 30. Additionally, the inflatable bladder 30 assists in keeping ice and snow away from the head 92 of the user 90. Melting of the snow and ice from the breath of the user 90, and subsequent refreezing into a shell around the head 92 (i.e., “ice mask”) is thereby prevented and facilitates the exchange of oxygen and carbon dioxide through the ice and snow.

In yet another example, the inflatable bladder 30, in the deployed position 30b, is maintained behind the user 90 and proximate the user 90 so as to lessen obstruction of movements of the user 90 while skiing, snowmobiling, or the like in an effort to evade the material slide or other such event. In another example, the inflatable bladder 30, when inflated, is retained within the silhouette of the user 90 to lessen resistance, wind or otherwise, of the inflatable bladder 30 while attempting to evade the material slide or other such event.

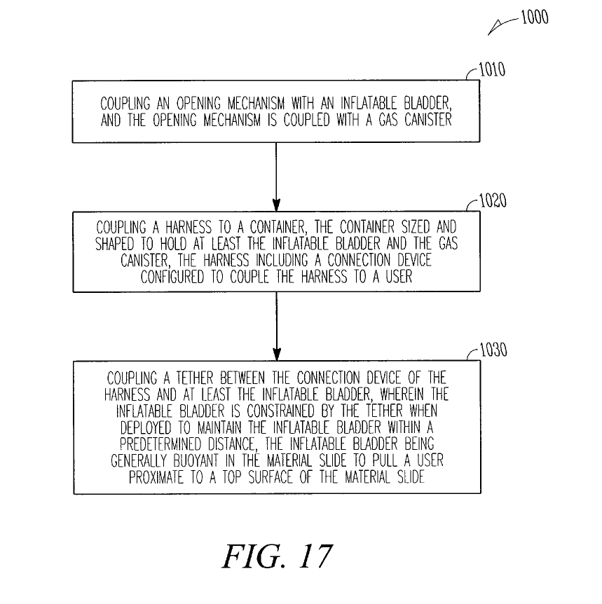

Referring now to FIG. 17, one example of a method 1000 of making a material slide rescue device 10, 10′ is depicted. Examples of a rescue device 10, 10′ made with the method 1000 are shown in FIGS. 1-16, and are referenced below. At 1010, an opening mechanism 60 is coupled with an inflatable bladder 30. The opening mechanism 60 is coupled with a gas canister 64. At 1020, a harness 40, 40′ is coupled to a container or pouch 24. The container or pouch 24 is sized and shaped to hold at least the inflatable bladder 30 and the gas canister 64. At 1030, a tether 50, 50′ is coupled between the harness 40, 40′ and at least the inflatable bladder 30. The inflatable bladder 30 is constrained by the tether 50, 50′ when deployed to maintain the inflatable bladder 30 within a predetermined distance A, A′. The inflatable bladder 30 is generally buoyant in the material slide to pull a user 90 proximate to a top surface of the material slide. Optionally, the method 1000 further includes coupling the tether 50, 50′ to a connection device 42 of the harness 40, 40′. In one example, the method 1000 includes forming the inflatable bladder 30, wherein the inflatable bladder 30, when deployed, is behind the user and, optionally, substantially within a silhouette of the user 90. Optionally, in one example, the rescue device 10, 10′ is coupled to a backpack 100. In another example, the rescue device 10, 10′ is coupled to a waist belt 102 of the backpack 100.

The above described examples of the rescue device are compact devices that fit comfortably on a user and allow full use of backpacks and other storage devices on the back of the user. The rescue device or harness, including, for example, straps, a vest, webbing, and the like, is sized and shaped to position a bundle on the user. In one example, the bundle, including the inflatable bladder, gas canister, and opening mechanism, is positioned near the waist, abdomen, chest, and the like of the user. The bundle is thereby positioned in a location that does not interfere with the activity of the user (e.g., skiing, climbing, hiking, snowmobiling, rescue operations, and the like). Additionally, the user may still wear a backpack or other back mounted device. In another example, the rescue device is secured to a backpack, for instance, secured to a bottom of the backpack, a waist belt of the back pack, or the like. Further, the rescue device is sized and shaped to remain on the user during a variety of activities, such as, skiing, hiking, snowmobiling, rescue operations, and the like, thereby ensuring the rescue device is available for use during a material slide or other such event (e.g., avalanche, rock slide, mud slide, and the like).

In another example, the rescue harness is sized and shaped to position the inflatable bladder, in an inflated condition, at a predetermined distance from the bundle, connection device, or the like, for instance, near the head of the user. The inflatable bladder thereby provides protection to the head. Positioning the inflatable bladder near the head of the user marks the location of the user and more specifically marks the location of the head of the user. Because the inflatable bladder is buoyant with respect to the slide material, the inflatable bladder should move to the upper surface of the material slide and be visible to rescuers. Optionally, the inflatable bladder has a substantially ring-shaped geometry and the rescue device is sized and shaped to position the pocket of the inflatable bladder near the mouth of the user to facilitate breathing during a material slide. Further, during the material slide, the user may grasp the inflated bladder and pull it close to his head to provide some protection from the moving objects in the slide (e.g., rocks, snow, mud and the like). In one example, the inflatable bladder includes handles for the user to grasp and pull the inflatable bladder close to the head. In another example, the inflatable bladder, in the deployed position, is maintained behind the user and proximate the user so as to lessen obstruction of movements of the user while skiing, snowmobiling, or the like in an effort to evade the material slide or other such event. In another example, the inflatable bladder, when inflated, is retained within the silhouette of the user to lessen resistance, wind or otherwise, of the inflatable bladder while attempting to evade the material slide or other such event.

In yet another example, when inflated, the inflatable bladder is positioned away from the center of gravity of the user, for instance, near the head and chest of the user. The inflatable bladder provides some drag to the user through the first tether, for instance. The drag from the inflatable bladder spaced from the center of gravity rotates the user within the material slide so the head of the user is pointed upstream with respect to the direction of material movement in the slide (e.g., uphill). Because the inflatable bladder is coupled to the rescue device near the head and chest of the user, the drag rotates the user around the center of gravity near the waist of the user. The head is thereby turned away and protected from oncoming downstream obstacles such as trees, rocks, ravines, cliffs and the like. Additionally, because the inflatable bladder is coupled on the front of the user, for instance through the tether coupled with the harness, the body of the user is turned to face upward by the buoyancy of the inflatable bladder in the material slide. The user is thereby positioned near the surface of the material slide and faces upward. This position and orientation assists in extracting the user from the slide (e.g., by himself or by others) and facilitates breathing within the pocket in the inflatable bladder.

Further rescue devices and methods therefor are discussed in U.S. patent application Ser. No. 11/284,433, filed Nov. 21, 2005, and entitled “Rescue Harness”. This patent is hereby incorporated by reference in its entirety.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A rescue device for use by a user in a material slide, the rescue device comprising:
a bundle including an inflatable bladder in a storage position;
a harness coupled to the bundle, the harness configured to secure the bundle to the user; and
a tether operatively coupling the inflatable bladder to the harness, wherein the inflatable bladder is constrained by at least the tether to remain within a predetermined distance from the harness to place the inflatable bladder, when in a deployed position, immediately adjacent the user to aid in protecting the user against blunt force trauma from the material slide.

2. The rescue device of claim 1, wherein the harness is a waist belt.

3. The rescue device of claim 1, wherein the harness is a bandolier.

4. The rescue device of claim 3, wherein the harness is configured to position the bundle on a chest of the user.

5. The rescue device of claim 1, wherein the inflatable bladder is generally buoyant in the material slide to pull the user proximate to a top surface of the material slide.

6. The rescue device of claim 1, wherein the inflatable bladder has a substantially ring-shaped geometry sized and shaped to form a pocket for placement and protection of a head of the user.

7. The rescue device of claim 1, wherein the inflatable bladder includes handles.

8. The rescue device of claim 1, further comprising at least one gas canister coupled with the inflatable bladder.

9. The rescue device of claim 1, wherein the inflatable bladder when deployed is substantially within a silhouette of the user.

10. A rescue device for use by a user in a material slide, the rescue device comprising:
a bundle including an inflatable bladder in a storage position;
at least a harness coupled to the bundle, the harness having a connection device configured to couple the harness to the user; and
a tether coupling the inflatable bladder to the connection device, wherein the inflatable bladder is constrained by at least the tether to remain within a predetermined distance from the connection device, the tether constraining the inflatable bladder in a deployed position to around a head of the user.

11. The rescue device of claim 10, wherein the bundle includes a sleeve through which a waist belt of a backpack slides.

12. The rescue device of claim 11, further comprising a failsafe strap configured to secure the bundle to the user in addition to the waist belt of the backpack retaining the bundle on the user.

13. The rescue device of claim 10, wherein the bundle includes a rip cord.

14. The rescue device of claim 10, wherein the inflatable bladder has a substantially ring-shaped geometry sized and shaped to form a pocket for placement and protection of the head of the user.

15. The rescue device of claim 10, wherein the inflatable bladder includes handles.

16. The rescue device of claim 10, wherein the bundle includes a pouch at least partially surrounding the inflatable bladder in the storage position.

17. The rescue device of claim 16, wherein the pouch is sized and shaped to split apart when the inflatable bladder is inflated.

18. The rescue device of claim 10, further comprising at least one gas canister coupled with the inflatable bladder.

19. The rescue device of claim 10, wherein the harness is configured so the connection device is disposed substantially proximate a frontal vertical midline of the user.

20. The rescue device of claim 10, wherein the tether is removably coupled at least partially along the harness, the tether configured to separate from the harness when the inflatable bladder is deployed.

21. A rescue device for use by a user in a material slide, the user wearing a backpack, the rescue device comprising:
a bundle adapted to be selectively secured to the backpack, the bundle including an inflatable bladder in a storage position; and
a tether coupling the inflatable bladder to the bundle, wherein the inflatable bladder is constrained by at least the tether to remain within a predetermined distance from the bundle, the inflatable bladder when deployed being generally buoyant in the material slide and pulling the user proximate to a top surface of the material slide.

22. The rescue device of claim 21, wherein the inflatable bladder is constrained by at least the tether to remain proximate to a head of the user.

23. The rescue device of claim 21, further comprising a backpack.

24. The rescue device of claim 21, further comprising a failsafe strap configured to secure the bundle to the user in addition to the backpack retaining the bundle on the user.

25. The rescue device of claim 21, wherein the predetermined distance maintains the inflatable bladder immediately adjacent the user when deployed to allow the user to continue skiing after deploying the inflatable bladder.

26. The rescue device of claim 21, wherein the inflatable bladder has a substantially ring-shaped geometry sized and shaped to form a pocket for placement and protection of a head of the user.

27. The rescue device of claim 21, wherein the inflatable bladder when deployed is substantially within a silhouette of the user.

28. A method of making a material slide rescue device, comprising:
coupling an opening mechanism with an inflatable bladder, and the opening mechanism is coupled with a gas canister;
coupling a harness to a container, the container sized and shaped to hold at least the inflatable bladder and the gas canister, the harness including a connection device configured to couple the harness to a user; and
coupling a tether between the connection device of the harness and at least the inflatable bladder, wherein the inflatable bladder is constrained by the tether when deployed to maintain the inflatable bladder within a predetermined distance, the inflatable bladder being generally buoyant in the material slide to pull a user proximate to a top surface of the material slide.

29. The method of claim 28, further comprising forming the inflatable bladder, wherein the inflatable bladder when deployed is substantially within a silhouette of the user.

30. The method of claim 28, further comprising removably coupling the tether at least partially along the harness, the tether configured to separate from the harness when the inflatable bladder is deployed.
